(19) United States
(12) Patent Application Publication
(10) Pub. No.: US 2025/0269521 A1
(43) Pub. Date: Aug. 28, 2025

(54) Device and Method for Natural Language Controlled Industrial Assembly Robotics

(71) Applicant: Robert Bosch GmbH, Stuttgart (DE)

(72) Inventors: Omkar Joglekar, Tel Aviv-Yafo (IL); Shir Kozlovsky, Sede Avraham (IL); Dotan Di Castro, Haifa (IL); Tal Lancewicki, Yavne (IL); Vladimir Tchuiev, Haifa (IL); Zohar Feldman, Haifa (IL)

(21) Appl. No.: 19/055,083

(22) Filed: Feb. 17, 2025

(30) Foreign Application Priority Data
Feb. 26, 2024 (EP) 24159755.8

(51) Int. Cl. B25J 9/16; B25J 19/02

(52) U.S. Cl. CPC B25J 9/161; B25J 9/163; B25J 9/1687; B25J 19/021

(57) ABSTRACT

A computer-implemented method of determining actions for controlling a robot, in particular an assembly robot, includes (i) receiving a first and second input, wherein the first input is a sentence describing an action which should be carried out by the robot, wherein the second input is an image of a current state of an environment of the robot, (ii) feeding the first input into a first machine learning model and feeding the second input into a second machine learning model, wherein the first and second machine learning models are configured to determine tokens for their respective inputs, and (iv) feeding the tokens into a third machine learning model, wherein the third machine learning model outputs two outputs, wherein the first output is a switch for incorporating specialized skill networks and the second output are actions.

### BACKGROUND

This application claims priority under 35 U.S.C. § 119 to patent application no. EP 24159755.8, filed on Feb. 26, 2024 in the Europen Patent Office, the disclosure of which is incorporated herein by reference in its entirety.

The disclosure concerns a method for determining actions for controlling a robot, in particular an assembly robot, based on natural language prompts and based on an image of an environment of the robot.

Large Language Models (LLMs) and transformer-based vision models recently have enabled rapid development in the field of Vision-Language-Action models for robotic control. The main objective of these methods is to develop a generalist policy that can control robots in various environments. Policies are well-known from the field of reinforcement learning.

However, in industrial robotic applications such as automated assembly and disassembly, some tasks, such as insertion, demand greater accuracy and involve intricate factors like contact engagement, friction handling, and refined motor skills. Implementing these skills using a generalist policy is challenging because these policies might integrate further sensory data, e.g. including force or torque measurements, for enhanced precision.

One objective of the present disclosure is to provide a locally precise and a globally robust control policy for a finite set of skills that are specifically trained to perform high-precision tasks.

In industrial robotic assembly, some tasks, such as insertion, demand greater accuracy and involve intricate factors like contact engagement, friction handling, and refined motor skills. The advantage of the present method lies in the introduction of a global control policy based on LLMs that is able through dynamic context switching to transfer the control policy to a finite set of skills that are specifically trained to perform high-precision tasks. The ability to take up independently skill models is also an advantage. Furthermore, the integration of LLMs is not only advantageously for interpreting and processing language inputs but also for enriching the control mechanisms for diverse and intricate robotic operations.

### SUMMARY

In a first aspect, a computer-implemented method of determining actions for controlling a robot, in particular an assembly robot, is proposed as set forth below. Advantageously, the method is applied to assembly processes that require a sequence of skills. This is advantageous as the proposed method supports the prediction of intricate assembly processes that require a sequence of skills. For this purpose, after a completion of a skill, the model can predict a new skill as continuation of the process, which is similarly derived from the two inputs described (text, image). If for the purpose of inferring the next skill, the current state does not encapsulate all the information required (AKA the system is Markovian), one can add as inputs not only the last image but also additional images from history, eg which have been previously stored.

The method starts with receiving a first and second input, wherein the first input is a sentence describing a (assembly) task for the robot. The sentence can be a sentence in a natural language, also referred to as a natural language prompt. The task can be described by defining a goal or a (general) action that should be achieved or carried out by the robot. The second input is a sensor output, in particular an image, characterizing a current state of an environment of the robot.

Subsequently, the first and second input are feed into a first and second machine learning model, respectively. The first and second machine learning models are configured to determine tokens for their respective inputs. Tokens are machine understandable low dimensional representations of the inputs and can be also referred to as embeddings.

Subsequently, the determined tokens of the first and second machine learning models are grouped together also referred to as a concatenation.

Subsequently, the concatenated tokens are feed into a third machine learning model. The third machine learning model comprises two policies that are configured to output a skill action (aₛ) and a moving action (aₘ), respectively.

The skill action (aₛ) is a categorization or classification of high-level categorization of action. Preferably, the categories of the skills are independent from each other. The skill action (aₛ) can be understood as an identifier or pointer to the category of skill or action that will achieve the best result out of the set of skills. It is noted that said skills are not conditioned on the text instruction. The skill action (aₛ) directly can be used to fetch the appropriate skill or the method behind the skill to be executed. The high-level categories represent general actions, which the robot could carry out for the current state of the environment in order to fulfill its task according to the language prompt.

The skill action is determined based on the concatenated tokens. In case that read-out tokens are utilized, preferably, the skill action is only determined based on the outputted read-out tokens.

The moving action (aₘ) is an explicit movement proposal for the robot. Moving actions are movement information in which direction and preferably, by which distance the robot should move.

Subsequently, based on the skill action (aₛ) it is decided whether the moving action (aₘ) is outputted as action for the robot or a more precise movement proposal than the moving action (aₘ) for the action is provided from an external source. The external source can be a database comprising methods for determining precise movement proposals for the respective high-level categories. Said methods can be dedicated neural networks for their corresponding skill.

Preferably the method of the first aspect of the disclosure is used for a language-driven robotic industrial assembly solution.

It is proposed that the external source comprises a set of specialized skills, wherein the specialized skills are methods configured to provide a movement proposal for the specific skill, wherein the specialized skills are provided with additional sensory input of the current state of the robot and of the environment of the robot.

Furthermore, it is proposed that the skill action (aₛ) comprises a list of different high-level action categories, wherein the high-level actions categories are Terminate, Moving according to the moving action (aₘ) and different predefined speziallied skills. The corresponding policy for the skill action can determine logits for each of the categories. The decision for the action can be carried out by taking the categorie of the largest or smallest logits. Preferably, the specialized skills provide a greater accuracy and involve intricate factors like contact engagement, friction handling, and refined motor skills.

Furthermore, it is proposed that the during the concatenation of the tokens read-out tokens are added. The read-out tokens can be determined by an additional transformer model with e.g. at least one regular transformer layer.

### BRIEF DESCRIPTION OF THE DRAWINGS

Embodiments of the disclosure will be discussed with reference to the following figures in more detail. The figures show:

FIG. 1 a schematic framework of an embodiment of a robotic assembly controll;

FIG. 2 a schematic centralized controller architecture;

FIG. 3 a control system controlling a manufacturing machine;

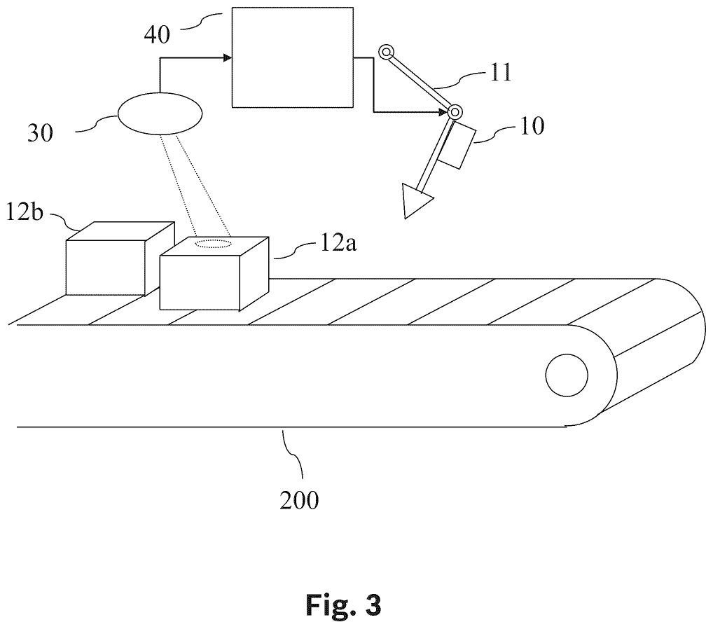

FIG. 4 a training system.

### DETAILED DESCRIPTION

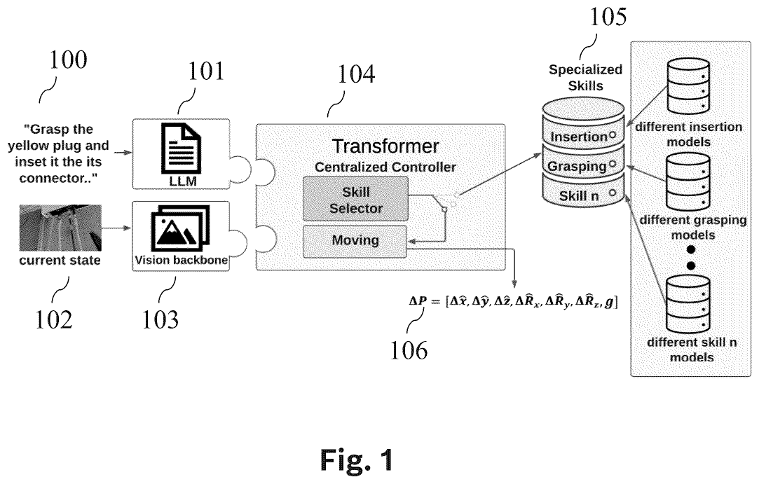

FIG. 1 shows a user-friendly industrial assembly framework based on natural language prompting and LLMs, which is easily adaptable to new environments and modular in adding or adjusting components to meet specific needs. The modular nature is evident in the system's inputs and outputs. Regarding input flexibility, the model is designed to support various types of specialized skills' neural network models.

The shown framework of FIG. 1 presents an approach that processes natural language-based goals from an assembly pipeline, such as “Carefully grasp the yellow plug and insert it into the appropriate socket.” (100) to output control instructions based on image observations. In principle, said framework comprises a centralized goal-conditioned model (104) that initiates readily available independent specialized skills (105), by handing over the control to specialized models based on context switching. The centralized module (104) is responsible for inferring the skill to be executed and moving the robot to an initial pose, enabling the specialized control model (skill model) to perform precise manipulation. Specifically, the centralized model (104) can output two control signals, namely (1) 6 Degree of Freedom (6DoF) pose for the default “move” action and (2) Skill-based context class.

The “skills” mentioned above can be small pre-trained networks specializing in fine-grained control tasks such as insertion. It is noted that other production task next to insertion are alternatively possible. The fine-grained skill “grasping for insertion” is utilized in the following as an example of specialized skill. The framework is modular in terms of the text and image encoders and the type of policy used (can be a simple Multi-Layer Perceptron). In addition, the framework is modular regarding specialized skills by simply fine-tuning the context classifier and calling the relevant policy to execute.

The centralized control model (104) is discussed in the following, employing a transformer architecture, which can adeptly switch between specialized control skills from a predefined set, guided by natural language objectives (100) and vision-based inputs (102).

This centralized controller fulfills two primary functions:
a. Direct the robot to a specified location based on the text prompts.
b. Identify and predict the necessary specialized skill, such as grasping or insertion, based on the textual prompt and the robot's current state.

The first function, which can be referred to as the general “moving” skill, doesn't necessitate a highly precise 6 Degrees of Freedom (6DoF) pose estimation. The specialized tasks mentioned in the second function demand greater accuracy and involve intricate factors like contact engagement, friction handling, and refined motor skills. Additionally, they might integrate further sensory data, including force or torque measurements, for enhanced precision. Distinct from the core model, these specialized skills are developed independently, for instance utilizing data specifically tailored to their requirements.

It can be assumed that these special skills work accurately, given that the robot meets certain constraints, e.g. such as being placed in an initial position that is in the proximity region of the manipulated object. The goal can be specified using a natural language prompt, for example, “Carefully grasp the yellow plug and insert it into the appropriate socket.”

The transformer model accepts language instruction tokens (101) that are encoded by strong language models (101) such as T5 (http://arxiv.org/abs/1910.10683), BLIP (http://arxiv.org/abs/2201.12086.) and CLIP (ttp://arxiv.org/abs/2103.00020.), that are pre-trained, frozen, and specialize in text encoding, and generate text instruction tokens. In addition, it is proposed to use pre-trained vision encoders (103), such as ResNet-50 or ViT (http://arxiv.org/abs/2010.11929.), to generate vision tokens that embed information from the observations. Preferably, the input is padded with learnable “readout tokens”, as described in Octo (https://octo-models.github.io.). The transformer can implement a Markovian policy, wherein the action depends solely on the current observation and is independent of past observations. In alignment with a dual-purpose model, it is possible to bifurcate the action into two categories: the skill action, denoted as aₛ, which pertains to the type of skill being executed, and the moving action, denoted as aₘ, which relates to the movement skill. The problem can be formally defined as follows:

aₛ=πₛ(s),

aₘ=πₘ(s),

where s is the state vector that encodes information about the current state (image(t)) and the general text prompt.

Preferably, both policies (πₛ(s), πₘ(s)) largely share their weights and architecture but differ in their decoder models. Both policies mentioned can be deterministic and based on a Multi-Layer Perceptron (MLP) architecture. The policy πₛ functions as a high-level controller, predicting the required skill by classifying predefined skills as follows:
0. Terminate
1. Moving (handled by the centralized controller)
2. Skill 1 (specialized)
3. Skill 2 (specialized)
4. Skill 3 (specialized)
5. etc.
n. Skill n (specialized)

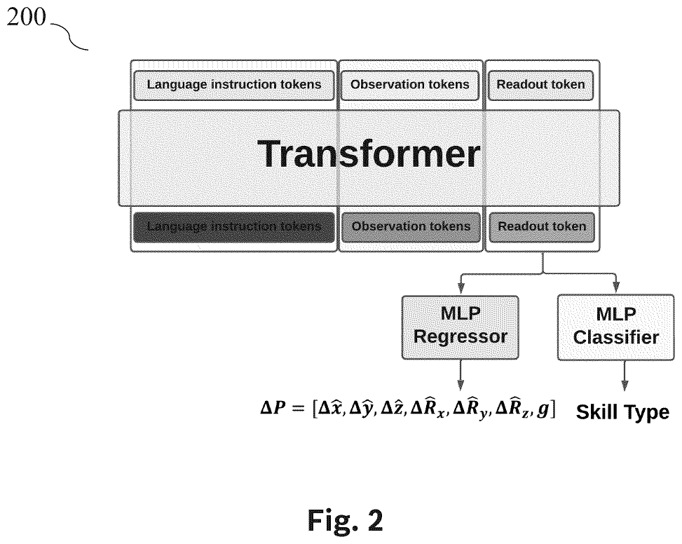

“Terminate” indicates that the robot has reached its goal per the provided text prompt. When aₛ=skill n, the control is handed over to the model specialized in skill n. When aₛ predicts the “moving” skill (denoted as “1”), the low-level controller's (πₘ) action is executed. Additional specialized skills can be integrated by adding another context class and fine-tuning the classification head with data pertinent to the new skill. FIG. 2 schematically shows said policies (200) by the transformer. The input of the transformer can be given by the previously determined tokens. The transformer can output transformed tokens. Preferably, the transformed read-out tokens are propagated through a MLP regressor and a MLP classifier to obtain the skill and moving action. In case that no read-out tokens are used, the regressor and classifier are applied to the language and/or observation tokens.

The action space of aₘ can be defined as a 7-dimensional vector, trained to predict a unit vector in the direction of the delta ground truth of the desired object or task using MSE loss. It is formulated as:

ΔP=[Δx,Δy,Δz,ΔRₓ,ΔR_{y},ΔR_{z},g]

In this formulation, Δx, Δy, Δz represent the translation components, while Δrₓ, Δr_{y}, Δr_{z} denote the orientation components represented in axis-angles, and g corresponds to the opening of the gripper. This 7-dimensional vector can be trained in a supervised manner using the Mean Squared Error (MSE) (Lₘₛₑ). ΔP is outputted as action (106) for the robot by the centralized controller (104) and can be directly used to control the robot. In general, the robot can comprise a gripper.

One can define active domain as the region that enables the successful execution of a specialized skill. The boundary of this active domain is assumed to be an abstract threshold ε. This threshold varies for different skills and is not solely dependent on distance. For instance, when guiding a grasped plug to a socket for insertion, the context should revert to the “grasping for insertion” specialized skill if the plug's position becomes unfavorable for insertion. A classifier head is trained to estimate this abstract threshold and facilitate context switching accordingly. This multi-class classifier head is trained using Categorical Cross Entropy loss (L_{ce}).

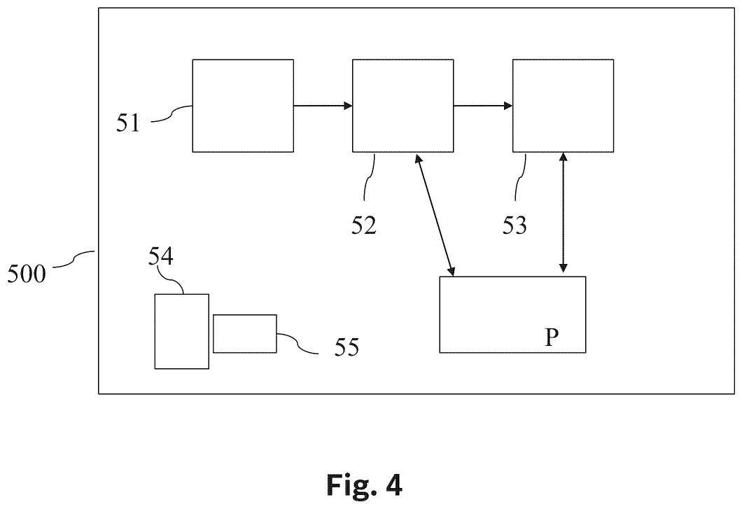

Shown in FIG. 4 is an embodiment in which control system 40 is used to control a manufacturing machine 11, e.g. a robot or a specific robot as a solder mounter, punch cutter, a cutter or a gun drill) of a manufacturing system 200, e.g. as part of an assembly line.

The control system 40 controls an actuator unit 10 which in turn control the manufacturing machine 11.

Sensor 30 may be given by an optical sensor which captures properties of e.g. a manufactured product 12. The actions 106 determined by the control system 40 can be applied to an actuator unit 10 which controls manufacturing machine 11 may then be controlled depending on the actions 106 to carry out a manufacturing step on a manufactured product 12a, 12b.

Shown in FIG. 5 is an embodiment of a training system 500. The training device 500 comprises a provider system 51, which provides inputs from a training data set. Inputs are fed to the framework 52 of FIG. 1 to be trained, which determines output variables from them. Output variables and input images are supplied to an assessor 53, which determines acute hyper/parameters therefrom, which are transmitted to the parameter memory P, where they replace the current parameters.

The procedures executed by the training device 500 may be implemented as a computer program stored on a machine-readable storage medium 54 and executed by a processor 55.

What is claimed is:

1. A computer-implemented method of determining actions for controlling a robot, comprising:
receiving a first and second input, wherein the first input is a sentence describing a task of the robot, wherein the second input is a sensor output characterizing a state of an environment of the robot;
feeding the first and second input into a first and second machine learning model respectively, wherein the first and second machine learning models are configured to determine tokens for their respective inputs;
concatenating the determined tokens of the first and second machine learning models;
feeding the concatenated tokens into a third machine learning model, wherein the third machine learning model comprises two policies that are configured to output a skill action and a moving action respectively, wherein the skill action characterizes a categorization of different high-level action categories of the robot and the moving action is an explicit movement proposal for the robot; and
deciding based on the skill action whether the moving action is outputted as action or a more precise movement proposal for the robot than the moving action as the action is determined according to the high-level action category of the skill action from an external source.

2. The method according to claim 1, wherein the external source comprises a set of specialized skills for the different high-level action categories, wherein the specialized skills are methods configured to provide a movement proposal for the respective high-level action category based on a state of the current environment of the robot, wherein the specialized skills are provided with additional sensory input of a current state of the robot and of the state the environment.

3. The method according to claim 1, wherein the first machine learning model is a pre-trained Large Language Model, and the second machine learning model is a pre-trained vision encoder.

4. The method according to claim 1, wherein the third machine learning model is a transformer model and the both policies share the transformer model as basis and differ by a regression head for outputting the moving action and a classification head for outputting the skill action.

5. The method according to claim 1, wherein the skill action comprises a list of different high-level action categories, wherein the high-level actions categories are terminate, moving according to the moving action and different predefined specialized skills.

6. The method according to claim 1, wherein during the concatenation of the tokens, additional read-out tokens are added.

7. The method according to claim 1, wherein a new specialized skill is added to the external source, wherein the different high-level action categories of the skill actions is expanded by an additional category for the new specialized skill, wherein the policy of the third machine learning model for the skill action is retrained by finetuning.

8. The method according to claim 1, wherein depending on the action a control signal for the robot is determined, wherein the robot is controlled to carry out the action by the control signal.

9. The method according to claim 1, wherein the robot is a manufacturing machine or an assembly robot.

10. A computer program that is configured to cause a computer to carry out the method according to claim 1 with all of its steps if the computer program is carried out by a processor.

11. A machine-readable storage medium on which the computer program according to claim 10 is stored.

12. A system that is configured to carry out the method according to claim 1.

13. The method according to claim 1, wherein the robot is an assembly robot.

14. The method according to claim 1, wherein the sensor output is an image.
